(19) United States
(12) Patent Application Publication
(10) Pub. No.: US 2025/0303489 A1
(43) Pub. Date: Oct. 2, 2025

(54) BUSBAR CLAMPING APPARATUS

(71) Applicant: HONDA MOTOR CO., LTD., Tokyo (JP)

(72) Inventors: Takayuki MOTOJIMA, Tokyo (JP); Hiroshi HAMANO, Tokyo (JP); Yasuhiro KAWAI, Saitama (JP); Toru EGUCHI, Saitama (JP); Masafumi YAMAZAWA, Tokyo (JP); Shunta AKIYA, Saitama (JP)

(21) Appl. No.: 19/061,946

(22) Filed: Feb. 24, 2025

(30) Foreign Application Priority Data
Mar. 29, 2024 (JP) 2024-058229

(51) Int. Cl. B23K 11/00; H01M 50/507; H01M 50/516

(52) U.S. Cl. CPC B23K 11/0073; H01M 50/507; H01M 50/516

(57) ABSTRACT

The busbar clamping apparatus includes a base member, a moving device, a first actuation part, a second actuation part, a drive device, and a control device. The first actuation part is mounted to the base member and arranged closer to the X+ side than the busbars that should be clamped. The second actuation part is mounted so as to be movable in the X direction relative to the base member and arranged closer to the X− side than the busbars that should be clamped. The control device causes the moving device to move the base member toward the X− side to move the first actuation part toward the X− side, and then causes the drive device to move the second actuation part toward the X+ side. This allows the first actuation part and the second actuation part to clamp the busbars in the X direction.

This application is based on and claims the benefit of priority from Japanese Patent Application No. 2024-058229, filed on 29 Mar. 2024, the content of which is incorporated herein by reference.

### FIELD OF THE INVENTION

### Background of the Invention

The present invention relates to a technology for electrically connecting tab leads of battery cells in a cell stack.

### Related Art

In recent years, the spread of electric vehicles (EVs) and hybrid electric vehicles (HEVs) has been progressing from the perspective of reducing carbon dioxide emissions and mitigating negative impacts on the global environment. Some batteries installed in such electric vehicles include a cell stack, in which a plurality of battery cells are arranged side by side in the X direction. Each battery cell includes tab leads that protrude in the Y direction.

Patent Document 1: Japanese Unexamined Patent

### SUMMARY OF THE INVENTION

The inventors of the present invention have considered to electrically connect the tab leads in such a cell stack in the following manner. First, busbars are arranged at the end of the cell stack in the Y direction. From this state, the busbars are clamped together with adjacent tab leads by an actuation pair consisting of a first actuation part and a second actuation part. In this state, the tab leads are welded to the busbars.

However, the inventors of the present invention have noted the following problems in the above cases. The drive system for the actuation pair is preferably as simple as possible due to space constraints. On the other hand, merely simplifying the drive system may reduce the functionality of the clamping operation of the busbars.

The present invention has been made in light of the above circumstances, and an object of the present invention is to simplify the drive system for the actuation pair while ensuring the functionality of the clamping operation of the busbars.

The inventors of the present invention have discovered that the above-mentioned object can be achieved by moving a base member mounted with the first actuation part to the X− side, and then moving the second actuation part to the X+ side relative to the base member, leading to the completion of the present invention. The present invention is a busbar clamping apparatus as described in the following aspects (1) to (6).

(1) A busbar clamping apparatus that clamps busbars together with adjacent tab leads in a cell stack that includes a plurality of battery cells arranged side by side in a predetermined X direction, each of the plurality of battery cells including a corresponding one of the tab leads protruding in a Y direction orthogonal to the X direction, in which the busbar clamping apparatus includes:
a base member;
a moving device that moves the base member;
a first actuation part mounted to the base member and arranged closer to the X+ side, which is one side in the X direction, than the busbars that should be clamped;
a second actuation part mounted so as to be movable in the X direction relative to the base member and arranged closer to the X− side, which is a side opposite to the X+ side, than the busbars that should be clamped;
a drive device that moves the second actuation part in the X direction relative to the base member; and
a control device that controls the moving device and the drive device, in which the control device causes the moving device to move the base member toward the X− side to move the first actuation part toward the X− side, and then causes the drive device to move the second actuation part toward the X+ side, thereby causing the first actuation part and the second actuation part to clamp the busbars in the X direction.

According to the present aspect, among the first actuation part and the second actuation part, only the second actuation part requires the drive device. Therefore, compared to the case where both the first actuation part and the second actuation part require the drive device, the drive system for the actuation pair including the first actuation part and the second actuation part can be simplified.

Furthermore, the control device moves the base member toward the X− side to move the first actuation part toward the X− side, and then moves the second actuation part toward the X+ side, thereby causing the first actuation part and the second actuation part to clamp the busbars in the X direction. In this manner, by moving the first actuation part in the X direction by moving the base member, the functionality of the clamping operation of the busbars can be ensured.

Thus, according to the present aspect, the drive system for the actuation pair can be simplified while ensuring the functionality of the clamping operation of the busbars.

(2) The busbar clamping apparatus as described in (1), in which the busbars are held so as to be movable in the X direction.

According to the present aspect, the busbars move to an appropriate position in the X direction by clamping the busbars, which are held so as to be movable in the X direction, together with the adjacent tab leads. The appropriate position is, for example, a position where the clamping forces from both sides in the X direction are balanced. Furthermore, in this case, the tab leads adjacent to the busbars bend following the movement of the busbars. Therefore, the busbars can be easily clamped without undue difficulty.

(3) The busbar clamping apparatus as described in (1) or (2), further including a plurality of actuation pairs, each consisting of the first actuation part and the second actuation part, in which
the control device executes batch clamping to clamp the plurality of busbars all together by using the plurality of actuation pairs.

According to the present aspect, the batch clamping allows a plurality of busbars to be efficiently clamped.

(4) The busbar clamping apparatus as described in (3), in which the control device executes batch clamping for either, from the X+ side toward the X− side, odd-numbered or even-numbered busbars and then executes batch clamping for the other of the odd-numbered or even-numbered busbars.

According to the present aspect, the actuation pairs only need to be provided for every other busbar among the plurality of busbars arranged side by side in the X direction. Therefore, the installation space for the actuation pairs and the corresponding drive devices can be easily secured in the X direction.

(5) The busbar clamping apparatus as described in any one of (1) to (4), in which the drive devices are arranged side by side in the X direction, and
each drive device includes: an air cylinder that applies a force in the Z direction, which is orthogonal to the X and Y directions; and a power conversion mechanism that converts the force in the Z direction from the air cylinder into a force in the X direction and transmits the converted force to the second actuation part.

According to the present aspect, each drive device includes an air cylinder that applies a force in the Z direction, thus tends to be longer in the Z direction but more compact in the X direction. Therefore, in this regard as well, the installation space for the drive devices arranged side by side in the X direction can be easily secured in the X direction.

(6) The busbar clamping apparatus as described in any one of (1) to (5), in which, within a range located on the X+ side beyond a predetermined first position, the center of gravity of each drive device closer to the X+ side is displaced more toward the X+ side than the center of gravity of the corresponding second actuation part driven by that drive device, and within a range located on the X− side beyond a predetermined second position, which is located on the X− side further beyond the first position, the center of gravity of each drive device closer to the X− side is displaced more toward the X− side than the center of gravity of the corresponding second actuation part driven by that drive device.

According to the present aspect, even in a case where the actuation pairs are densely arranged side by side in the X direction, the drive devices can be easily arranged as spread out in the X direction. Therefore, in this regard as well, the installation space for the drive devices arranged side by side in the X direction can be easily secured in the X direction.

As described above, according to the aspect (1), the drive system for the actuation pairs can be simplified while securing the functionality of the clamping operation for clamping the busbars. Furthermore, the aspects (2) to (6), which refer to the aspect (1), can achieve additional effects, respectively.

### BRIEF DESCRIPTION OF THE DRAWINGS

FIG. 1 is a plan sectional view illustrating a busbar holder mounting apparatus of a first embodiment and surroundings thereof;

FIG. 2 is a perspective view illustrating a cell stack and a busbar holder;

FIG. 3 is a front view illustrating the busbar holder;

FIG. 4 is a perspective view illustrating the busbar holder and a holder gripping tool;

FIG. 5 is an enlarged view of a portion of FIG. 4, specifically illustrating a positioning recess of the first embodiment and surroundings thereof;

FIG. 6 is a perspective view illustrating a positioning recess of a second embodiment and surroundings thereof;

FIG. 7 is a perspective view illustrating a comb tooth jig;

FIG. 8 is a plan view illustrating the cell stack;

FIG. 9 is a plan sectional view illustrating an initial step of mounting the busbar holder to the cell stack;

FIG. 10 is a plan sectional view illustrating the subsequent step;

FIG. 11 is a plan sectional view illustrating the next step;

FIG. 12 is a plan sectional view illustrating the further step;

FIG. 13 is a plan sectional view illustrating another subsequent step;

FIG. 14 is a plan sectional view illustrating the state in which the busbar holder has been mounted to the cell stack;

FIG. 15 is a plan sectional view illustrating the state in which the grip on the busbar holder by the holder gripping tool has been released;

FIG. 16 is a plan sectional view illustrating the state in which two busbar holders have been mounted to the cell stack;

FIG. 17 is a plan sectional view illustrating the busbar clamping apparatus and surroundings thereof;

FIG. 18 is a front view illustrating the busbar clamping apparatus;

FIG. 19 is a plan sectional view illustrating the state in which the odd-numbered busbars are clamped;

FIG. 20 is a plan sectional view illustrating the state in which the even-numbered busbars are clamped;

FIG. 21 is a plan sectional view illustrating an initial step of clamping the busbars;

FIG. 22 is a plan sectional view illustrating the subsequent step;

FIG. 23 is a plan sectional view illustrating the next step;

FIG. 24 is a plan sectional view illustrating the further step;

FIG. 25 is a plan sectional view illustrating another subsequent step;

FIG. 26 is a plan sectional view illustrating the state in which each tab lead has been welded to the adjacent busbar, at the X+ side portion at the Y− side end of the cell stack; and

FIG. 27 is a plan sectional view illustrating the state in which each tab lead has been welded to the adjacent busbar at both ends of the cell stack in the Y direction.

### DETAILED DESCRIPTION OF THE INVENTION

Hereinafter, embodiments of the present invention will be described with reference to the drawings. However, the present invention is not limited to the following embodiments and can be appropriately modified within a scope without departing from the spirit of the invention.

### First Embodiment

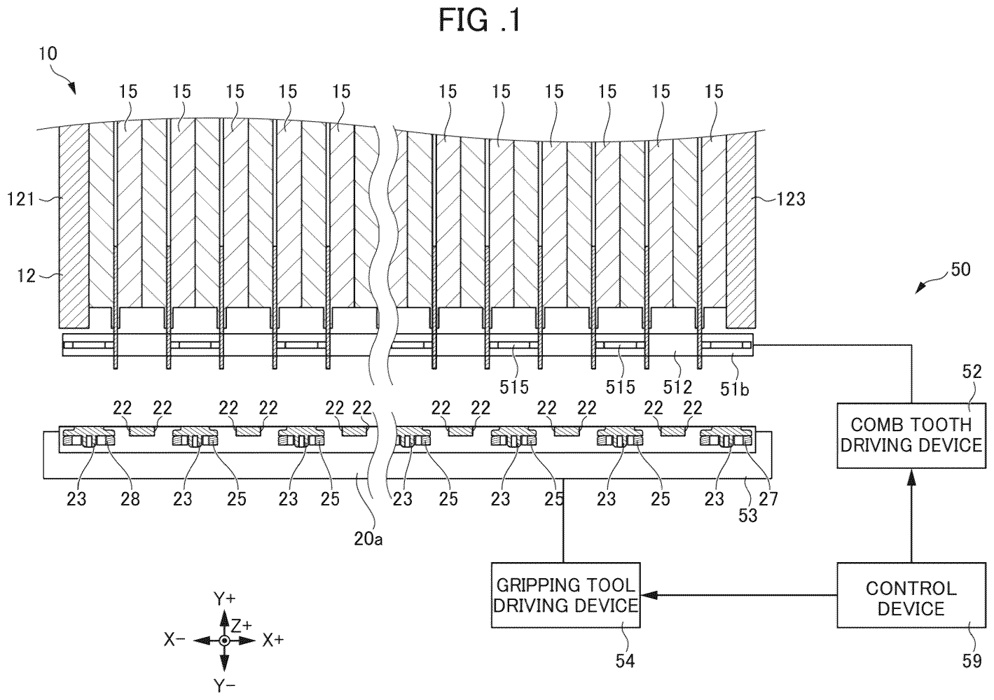

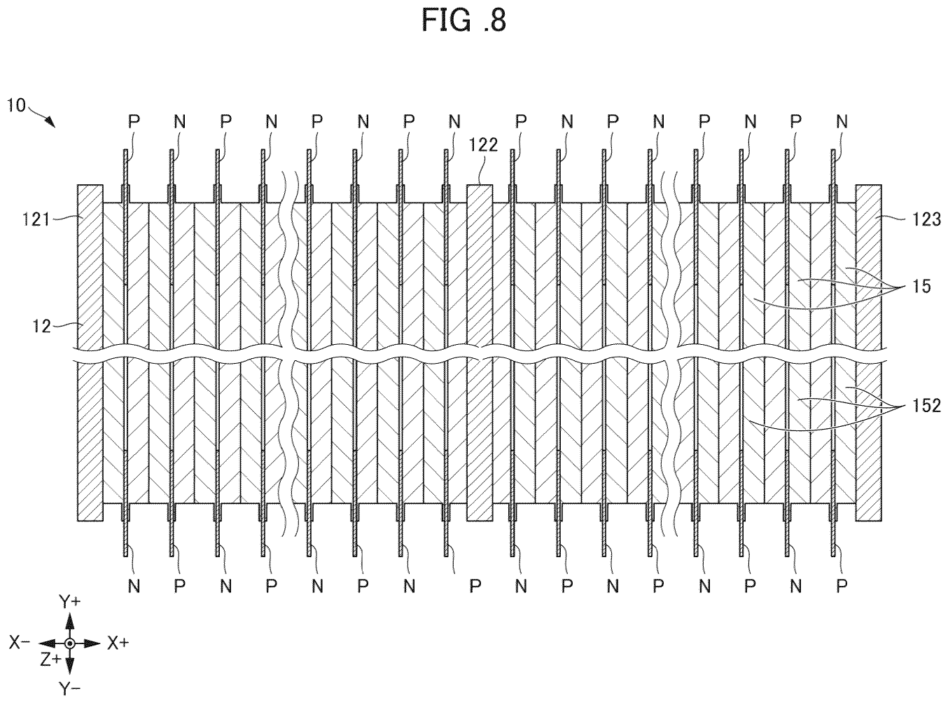

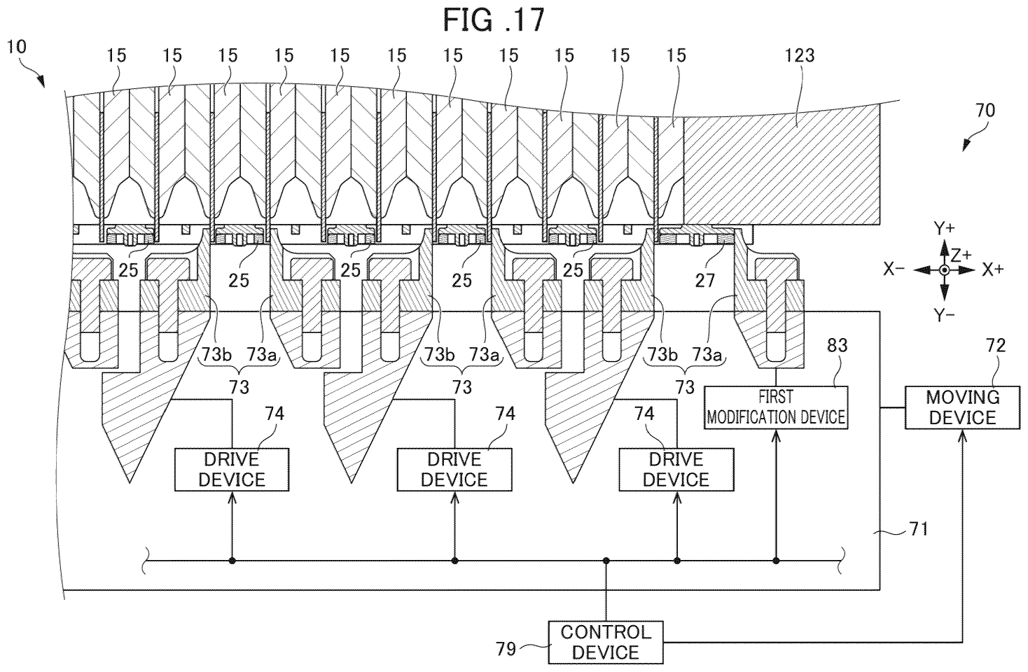

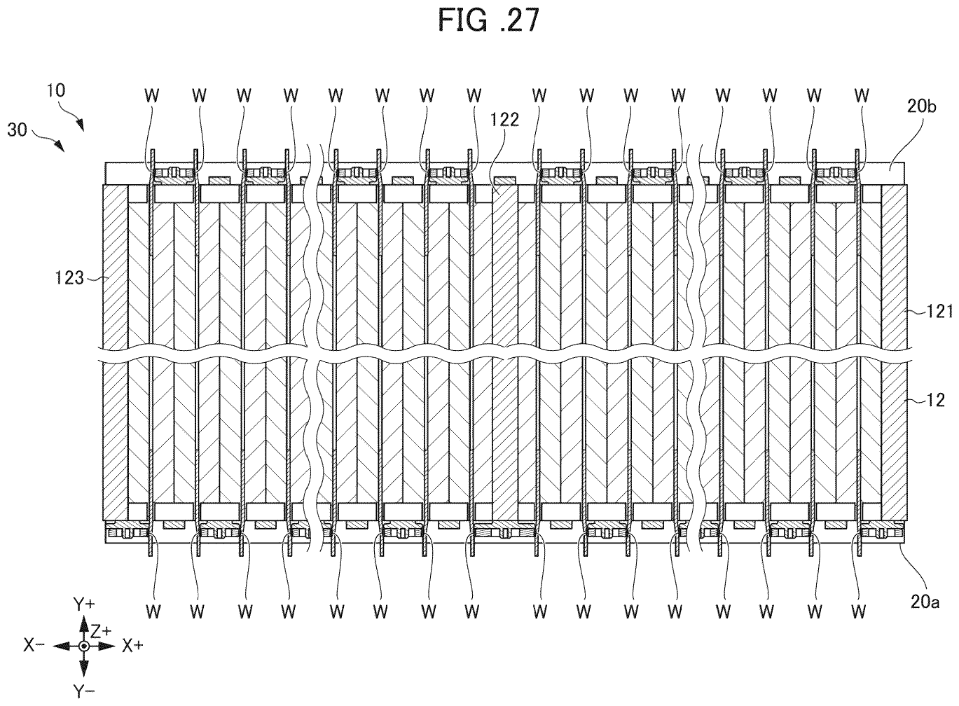

The present embodiment relates to a technique for mounting two busbar holders 20a, 20b illustrated in FIG. 27 to a cell stack 10 illustrated in FIG. 8, using a holder mounting apparatus 50 illustrated in FIG. 1 and a clamping apparatus 70 illustrated in FIG. 17. The “holder mounting apparatus” is an abbreviation for “busbar holder mounting apparatus”, and the “clamping apparatus” is an abbreviation for “busbar clamping apparatus”. As illustrated in FIG. 27, the cell stack 10 and the busbar holders 20a, 20b respectively form parts of the battery module 30.

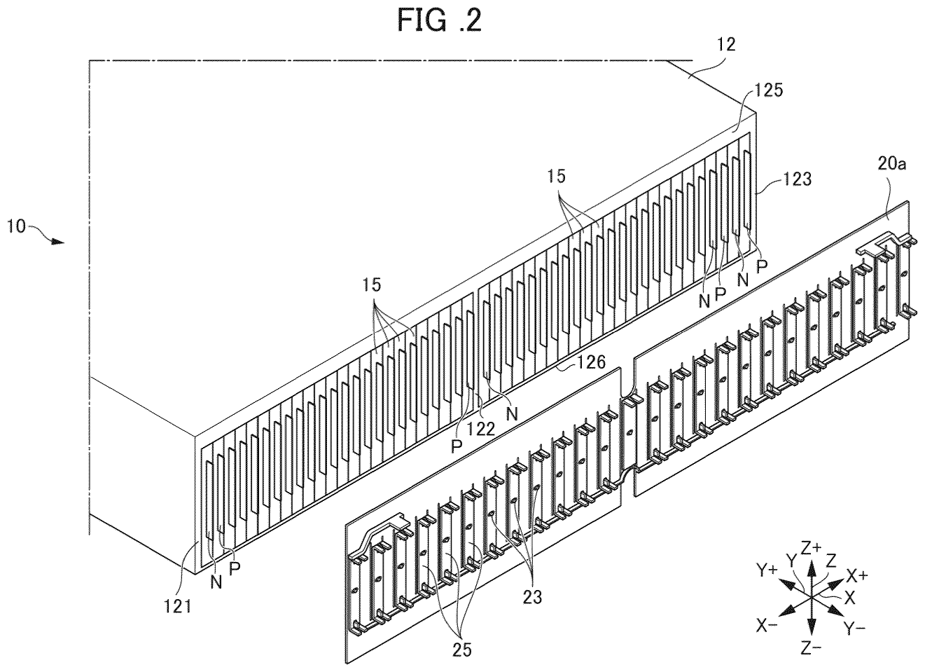

As illustrated in FIG. 2, three predetermined directions orthogonal to each other with respect to the cell stack 10 are referred to as the “X direction”, “Y direction”, and “Z direction”. One side in the X direction is referred to as the “X− side”, and the opposite side is referred to as the “X+ side”. Similarly, one side in the Y direction is referred to as the “Y− side”, and the opposite side is referred to as the “Y+ side”. Furthermore, one side in the Z direction is referred to as the “Z− side”, and the opposite side is referred to as the “Z+ side”.

In the present embodiment, the Z direction is the vertical direction, and the X and Y directions are the horizontal directions. However, alternatively, the X or Y direction may be the vertical direction, and the remaining two directions may be the horizontal directions. Furthermore, one of the X, Y, and Z directions may be a direction diagonal to the vertical direction, and the other two directions may be orthogonal to the diagonal direction.

First, the cell stack 10, as illustrated in FIG. 2, will be described. The cell stack 10 includes a housing 12 and a plurality of battery cells 15.

The housing 12 includes a side plate 125 on the Z+ side, a side plate 126 on the Z− side, an end plate 121 on the X− side, a center plate 122, and an end plate 123 on the X+ side.

The side plate 125 on the Z+ side extends in the X and Y directions. The side plate 126 on the Z− side extends in the X and Y directions, located closer to the Z− side than the side plate 125 on the Z+ side. Hereinafter, the side plate 125 on the Z+ side and the side plate 126 on the Z− side are referred to as the two side plates 125, 126.

The end plate 121 on the X− side extends in the Y and Z directions, connecting the X− side ends of the two side plates 125, 126. The center plate 122 extends in the Y and Z directions, connecting the middle portions of the two side plates 125, 126 in the X direction. The end plate 123 on the X+ side extends in the Y and Z directions, connecting the X+ side ends of the two side plates 125, 126.

Inside the housing 12, the battery cells 15 extending in the Y and Z directions are housed side by side in the X direction. Specifically, half of the battery cells 15 are housed between the end plate 121 on the X− side and the center plate 122. The remaining half of the battery cells 15 are housed between the center plate 122 and the end plate 123 on the X+ side.

As illustrated in FIG. 8, each battery cell 15 includes a cell body 152, Y+ side tab leads P and N protruding from the Y+ side end of the cell body 152 toward the Y+ side, and Y− side tab leads N and P protruding from the Y− side end of the cell body 152 toward the Y− side. In each battery cell 15, one of the two tab leads P and N on the Y+ and Y− sides is a positive electrode-side tab lead P, and the other is a negative electrode-side tab lead N.

Hereinafter, the arrangement of the battery cell 15, in which the positive electrode-side tab lead P is arranged on the Y+ side and the negative electrode-side tab lead N is arranged on the Y− side, is referred to as the “positive-negative arrangement”. The arrangement of the battery cell 15, in which the negative electrode-side tab lead N is arranged on the Y+ side and the positive electrode-side tab lead P is arranged on the Y− side, is referred to as the “negative-positive arrangement”.

In the cell stack 10, the battery cells 15 in the positive-negative arrangement and the battery cells 15 in the negative-positive arrangement are alternately arranged in the X direction. Specifically, the battery cell 15 located closest to the X− side is in the positive-negative arrangement. The battery cell 15 adjacent to the center plate 122 on the X− side is in the negative-positive arrangement. The battery cell 15 adjacent to the center plate 122 on the X+ side is in the positive-negative arrangement. The battery cell 15 located closest to the X+ side is in the negative-positive arrangement.

As a result, the positive electrode-side tab leads P and the negative electrode-side tab leads N are alternately arranged in the X direction at both the Y+ side end of the cell stack 10 and the Y− side end of the cell stack 10.

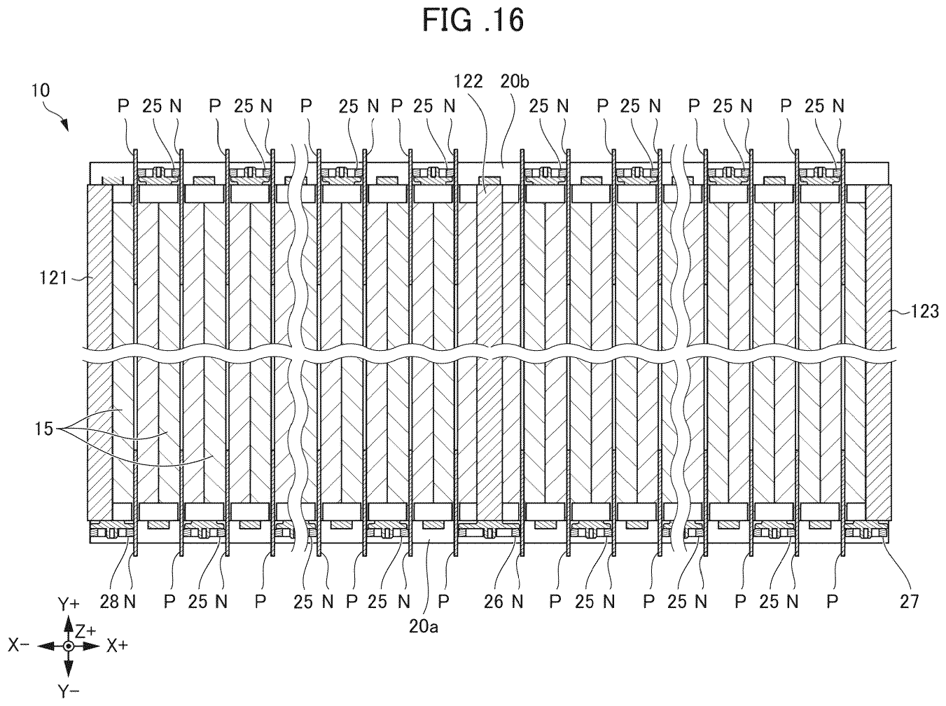

Next, the two busbar holders 20a and 20b, as illustrated in FIG. 16, will be described. The two busbar holders 20a and 20b consist of a first busbar holder 20a and a second busbar holder 20b. The first busbar holder 20a is mounted to the Y− side end of the cell stack 10. The second busbar holder 20b is mounted to the Y+ side end of the cell stack 10.

Hereinafter, the state in which the first busbar holder 20a is mounted to the Y− side end of the cell stack 10 is referred to as the “first mounting state”. The state in which the second busbar holder 20b is mounted to the Y+ side end of the cell stack 10 is referred to as the “second mounting state”. The first mounting state and the second mounting state are collectively referred to as the “mounting state”. Hereinafter, the odd-numbered positions from the X+ side toward the X− side are simply referred to as “odd-numbered”, and the even-numbered positions from the X+ side toward the X− side are simply referred to as “even-numbered”.

First, the first busbar holder 20a, as illustrated in FIG. 1, will be described. The first busbar holder 20a, as viewed in the first mounting state, is configured as follows.

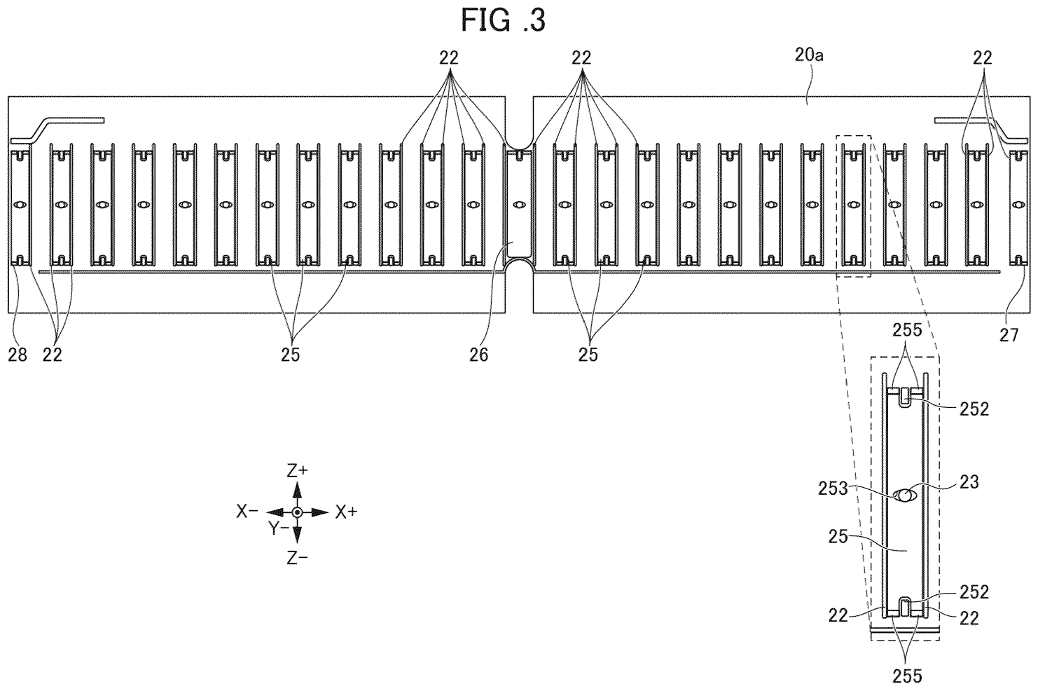

As illustrated in FIG. 2, the first busbar holder 20a extends in the X and Z directions. As illustrated in FIG. 3, the first busbar holder 20a includes insertion holes 22 extending in the Z direction and arranged side by side at intervals in the X direction. These insertion holes 22 are elongated holes for inserting the tab leads N and P. The term “insertion holes 22” may be read as “insertion portions”.

A positive-side end busbar 27 is held at a position that is closer to the X+ side than the insertion hole 22 located closest to the X+ side. The positive-side end busbar 27 is a conductor for connecting the positive electrode-side tab lead P of the battery cell 15 located closest to the positive side to the positive terminal of the entire battery module 30. This positive-side end busbar 27 extending in the Z direction, extends from the Z+ side end toward the X− side.

Normal-width busbars 25 are held, at all but one central portion in the X direction, between each even-numbered insertion hole 22 and the adjacent insertion hole 22 on the X− side. These normal-width busbars 25 extending in the Z direction are conductors for electrically connecting the negative electrode-side tab lead N of the even-numbered battery cells 15 to the positive electrode-side tab lead P of the adjacent battery cells 15 on the X− side.

On the other hand, a central busbar 26 is held at one central portion in the X direction. The central busbar 26 extending in the Z direction is a conductor for electrically connecting the negative electrode-side tab lead N of the battery cell 15 adjacent to the center plate 122 on the X+ side to the positive electrode-side tab lead P of the battery cell 15 adjacent to the center plate 122 on the X− side.

A negative-side end busbar 28 is held at a position that is closer to the X− side than the insertion hole 22 located closest to the X− side. The negative-side end busbar 28 is a conductor for connecting the negative electrode-side tab lead N of the battery cell 15 located closest to the negative side to the negative terminal of the entire battery module 30. The negative-side end busbar 28 extending in the Z direction, extends from the Z+ side end toward the X+ side.

Hereinafter, the central busbar 26, the positive-side end busbar 27, and the negative-side end busbar 28 are collectively referred to as “special-width busbars 26 to 28”. The width of these special-width busbars 26 to 28 in the X direction is greater than the width of the normal-width busbars 25 in the X direction. Hereinafter, the normal-width busbars 25 and the special-width busbars 26 to 28 are collectively referred to as “busbars 25 to 28”. Hereinafter, even when describing the individual busbars 25 to 28, the “busbar 25” may be appropriately used for describing the busbar 25 as an example. The same applies when describing some predetermined busbars as examples.

As illustrated in FIG. 3, the first busbar holder 20a includes a holding pin 23 for each of the busbars 25 to 28. Each holding pin 23 protrudes toward the Y− side. An elongated hole 253, extending in the X direction, is formed at a middle portion of each of the busbars 25 to 28 in the Z direction. By inserting the holding pin 23 into the elongated hole 253, the busbar 25 is held by the first busbar holder 20a so as to be movable in the X direction within the range of the elongated hole 253 and pivotable around the holding pin 23 as an axis. A restriction structure 252 is provided between the first busbar holder 20a and each busbar 25 to 28 to restrict the range of pivoting the busbars 25 to 28 around the holding pin 23 as an axis.

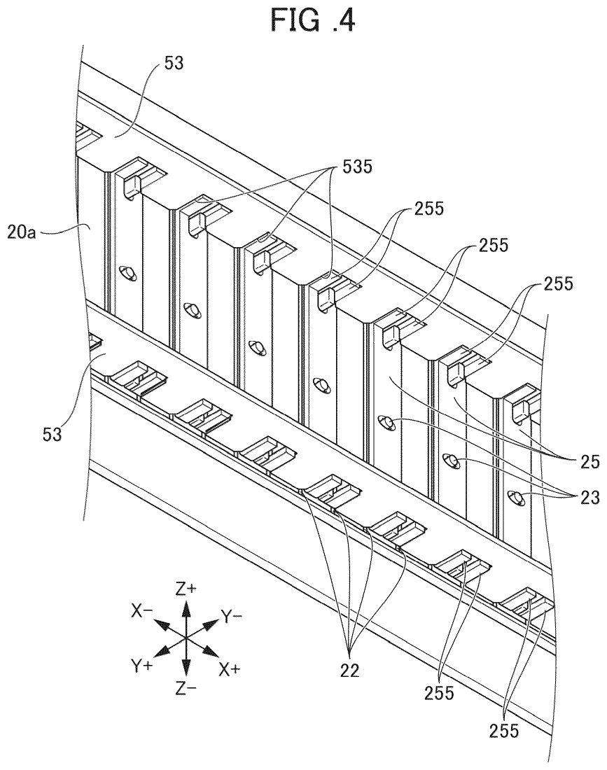

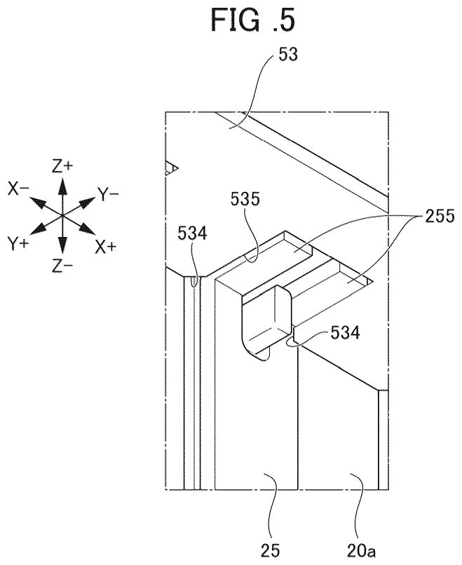

As illustrated in FIG. 5, at least one end of the busbars 25 to 28 in the Z direction includes a pair of protrusions 255. Therefore, for example, as illustrated in FIG. 4, the pair of protrusions 255 may be provided at each of both ends of the busbar 25 in the Z direction, or the pair of protrusions 255 may be provided only at one end of the busbar 25 in the Z direction. The pair of protrusions 255 are spaced apart in the X direction and protrude toward the Y− side. The role of the protrusions 255 will be described later.

The above has described the first busbar holder 20a as viewed in the first mounting state as mentioned earlier.

The following describes the second busbar holder 20b, as illustrated in FIG. 16. The description of the second busbar holder 20b will focus on the differences from the first busbar holder 20a, and the same or similar points as those of the first busbar holder 20a will be omitted as appropriate.

The second busbar holder 20b holds only the plurality of normal-width busbars 25. The normal-width busbars 25 electrically connect the negative electrode-side tab lead N of the odd-numbered battery cells 15 to the positive electrode-side tab lead P of the adjacent battery cells 15 on the X− side.

Hereinafter, even when describing the busbar holders 20a and 20b, the “busbar holder 20a” may be appropriately used for describing the first busbar holder 20a as an example.

The following describes the holder mounting apparatus 50, as illustrated in FIG. 1. The holder mounting apparatus 50 is configured to be capable of mounting the first busbar holder 20a to the Y− side end of the cell stack 10. The holder mounting apparatus 50 is also configured to be capable of mounting the second busbar holder 20b to the Y+ side end of the cell stack 10. The holder mounting apparatus 50, as viewed in the first mounting state, is configured as follows.

The holder mounting apparatus 50 includes two comb tooth jigs 51a and 51b, a comb tooth driving device 52, a holder gripping tool 53, a gripping tool driving device 54, and a control device 59.

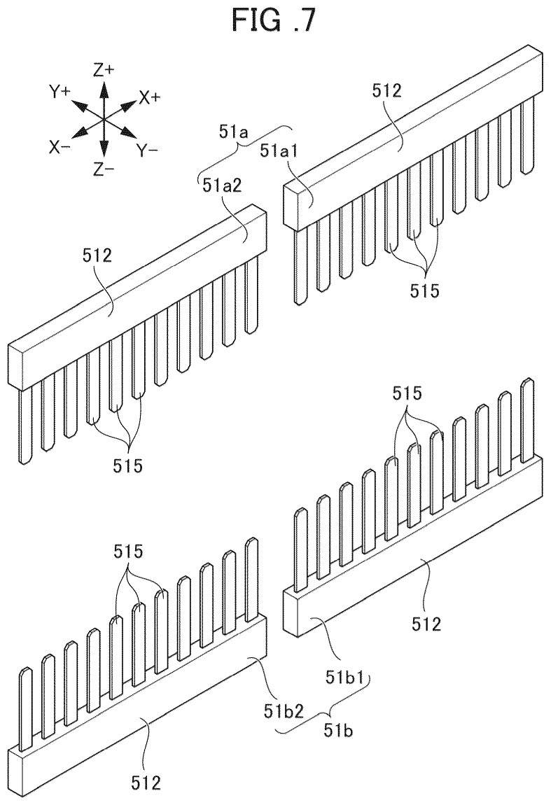

As illustrated in FIG. 7, the two comb tooth jigs 51a and 51b consist of the Z+ side comb tooth jig 51a and the Z− side comb tooth jig 51b. The Z+ side comb tooth jig 51a is arranged above the plurality of Y− side tab leads N and P of the cell stack 10. The Z− side comb tooth jig 51b is arranged below the plurality of Y− side tab leads N and P of the cell stack 10.

Each of the comb tooth jigs 51a and 51b is comb-shaped and includes comb teeth 515 extending in the Z direction, and a connecting portion 512 that connects the base ends of the comb teeth 515. The Z+ side comb tooth jig 51a is divided into an X+ side portion 51a1 and an X− side portion 51a2, which are configured to be capable of modifying the gap between the X+ side portion 51a1 and the X− side portion 51a2 in the X direction. Similarly, the Z− side comb tooth jig 51b is also divided into an X+ side portion 51b1 and an X− side portion 51b2, which are configured to be capable of modifying the gap between the X+ side portion 51b1 and the X− side portion 51b2 in the X direction. The tips of the comb teeth 515 of the Z+ side comb tooth jig 51a point toward the Z− side. On the other hand, the tips of the comb teeth 515 of the Z− side comb tooth jig 51b point toward the Z+ side.

The comb tooth driving device 52, as illustrated in FIG. 1, is configured to be capable of driving the two comb tooth jigs 51a and 51b in the Z direction.

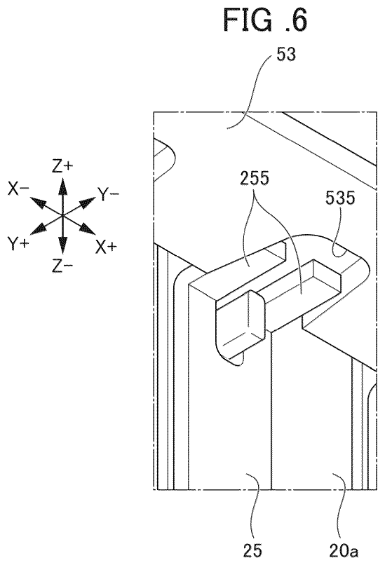

The holder gripping tool 53 illustrated in FIG. 1, is configured to be capable of gripping the first busbar holder 20a from the Y− side. As illustrated in FIG. 4, a plurality of positioning recesses 535, which are recessed toward the Y− side and arranged side by side in the X direction, are respectively provided at predetermined positions of the holder gripping tool 53. The inner surfaces of the positioning recesses 535 engage with the protrusions 255 of the busbars 25 to 28, thereby positioning the busbars 25 to 28 in the X direction relative to the holder gripping tool 53 and the first busbar holder 20a. That is, for example, as illustrated in FIG. 4, in a case where both ends of the busbar 25 in the Z direction include the pair of protrusions 255, the busbars 25 to 28 are positioned at these both ends in the X direction relative to the holder gripping tool 53 and the first busbar holder 20a. The specific aspect of the positioning recess 535 may be, for example, the first aspect illustrated in FIG. 5 or the second aspect illustrated in FIG. 6.

In the first aspect illustrated in FIG. 5, both side surfaces of the pair of protrusions 255 abut the inner side surfaces of the positioning recess 535, thereby positioning the busbar 25 in the X direction relative to the holder gripping tool 53. Furthermore, the tip surfaces of the protrusions 255 abut the bottom surface of the positioning recess 535, thereby positioning the busbar 25 in the Y direction relative to the holder gripping tool 53. A guide surface 534 is provided around the positioning recess 535 of the holder gripping tool 53 to guide the pair of protrusions 255 into the positioning recess 535.

In the second aspect illustrated in FIG. 6, the width of the positioning recess 535 in the X direction narrows toward the Y− side. The both side surfaces of the pair of protrusions 255 abut the inner surfaces of the positioning recess 535, thereby positioning the busbar 25 in the X and Y directions relative to the holder gripping tool 53.

The gripping tool driving device 54 illustrated in FIG. 1 is configured to be capable of driving the holder gripping tool 53 in the Y direction and executing the gripping and releasing operations of the first busbar holder 20a by the holder gripping tool 53. The gripping and releasing operations may be mechanically linked to the driving of the holder gripping tool 53 in the Y direction or may be executed independently of such movement in the Y direction.

The control device 59 illustrated in FIG. 1, controls the comb tooth driving device 52 and the gripping tool driving device 54, thereby executing predetermined positioning control, opening control, mounting control, and releasing control. Thus, the first busbar holder 20a is mounted to the Y− side end of the cell stack 10.

These “positioning control”, “opening control”, “mounting control”, and “releasing control” may be read as the “positioning step”, “opening step”, “mounting step”, and “releasing step”, respectively. In other words, the control device 59 automatically executes the busbar holder mounting method that includes the positioning step, the opening step, the mounting step, and the releasing step.

The above has described the holder mounting apparatus 50 as viewed in the first mounting state, as mentioned earlier.

The following describes the procedure for mounting the first busbar holder 20a to the Y− side end the cell stack 10, using the holder mounting apparatus 50 as described above.

First, as illustrated in FIG. 1, the operator sets the Y− side end of the cell stack 10 and the first busbar holder 20a into the holder mounting apparatus 50. Then, the holder mounting apparatus 50 is activated. Thus, the control device 59 of the holder mounting apparatus 50 executes the above-described positioning control, opening control, mounting control, and releasing control.

First, in the positioning control, the gripping tool driving device 54 drives the holder gripping tool 53, thereby allowing the holder gripping tool 53 to grip the first busbar holder 20a on the side closer to the Y− side than the plurality of Y− side tab leads N and P. In this case, as illustrated in FIG. 4, the protrusions 255 of the busbars 25 to 28 engage with the respective positioning recesses 535, thereby positioning the busbars 25 to 28 in the X direction relative to the holder gripping tool 53 and the first busbar holder 20a.

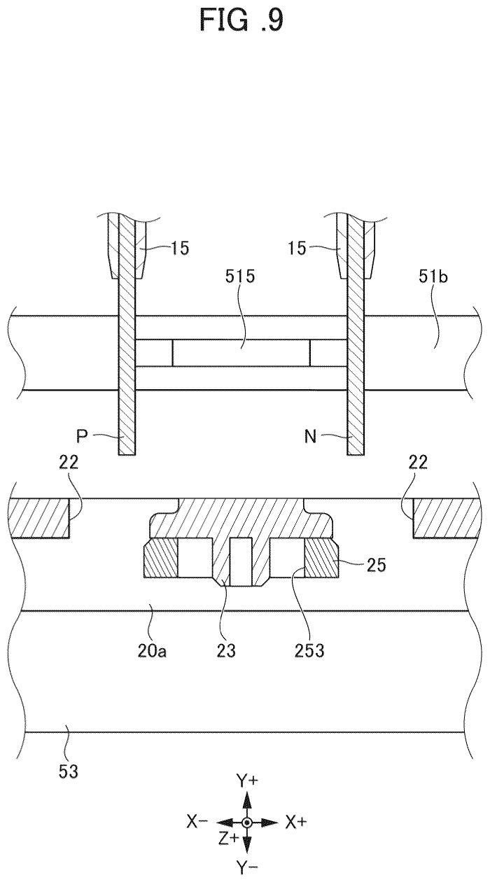

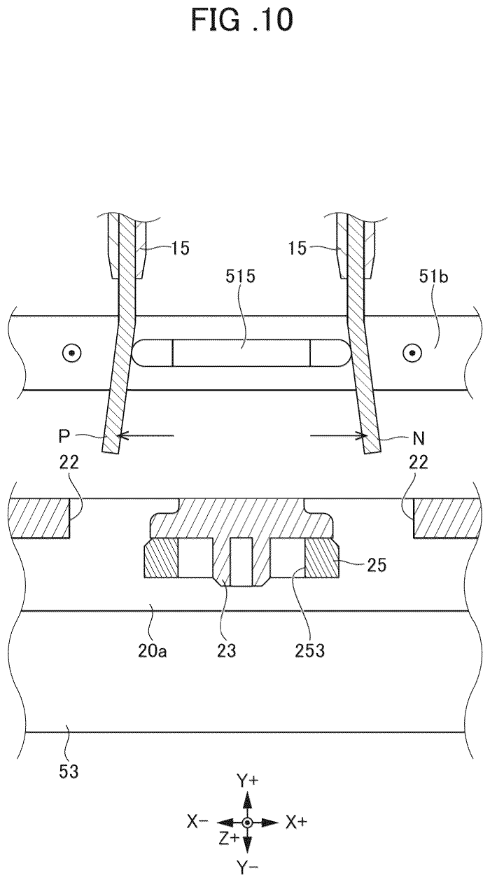

On the other hand, in the opening control, from the initial state as illustrated in FIG. 9, the comb tooth driving device 52 drives the Z− side comb tooth jig 51b toward the Z+ side, and drives the Z+ side comb tooth jig 51a toward the Z− side, as illustrated in FIG. 10. Thus, the Z− side comb tooth jig 51b is inserted toward the Z+ side, and the Z+ side comb tooth jig 51a is inserted toward the Z− side, between the tab leads P and N that should be electrically connected. As a result, the tips of the tab leads P and N are opened in the X direction.

The positioning control and the opening control may be executed in any sequence, with one preceding the other, or both executed simultaneously.

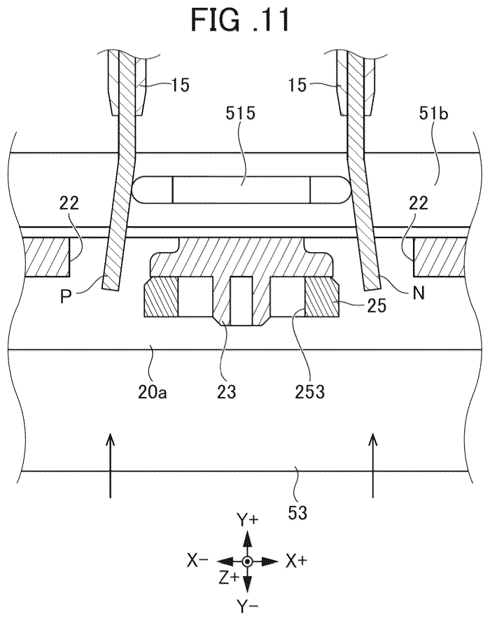

In the mounting control, which follows the positioning control and the opening control, the gripping tool driving device 54 moves the holder gripping tool 53 and the first busbar holder 20a illustrated in FIG. 10 from the side closer to the Y− side than the plurality of Y− side tab leads P and N toward the Y+ side, as illustrated in FIG. 11. This movement causes the tips of the tab leads P and N, i.e., the Y− side ends, to pass through the insertion holes 22. When viewed in the X-direction, the tips of the tab leads P and N overlap the busbars 25 to 28.

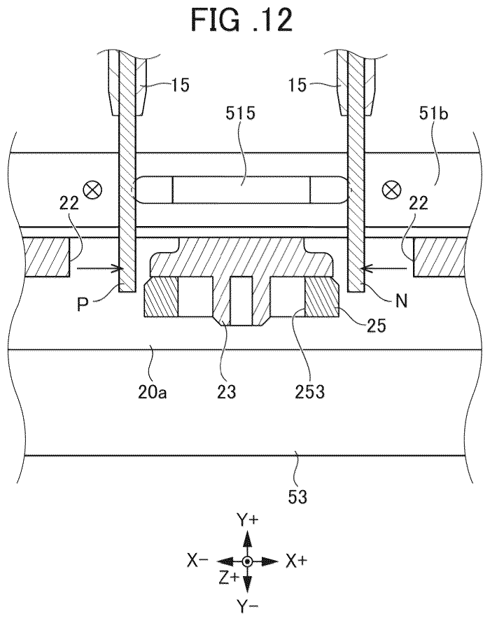

From this state, as illustrated in FIG. 12, the Z− side comb tooth jig 51b is moved toward the Z− side, and the Z+ side comb tooth jigs 51a is moved toward the Z+ side. Thus, the comb tooth jigs 51a and 51b are removed from between the tab leads P and N. Consequently, the gap in the X direction between the tips of the tab leads P and N, which should be electrically connected, narrows.

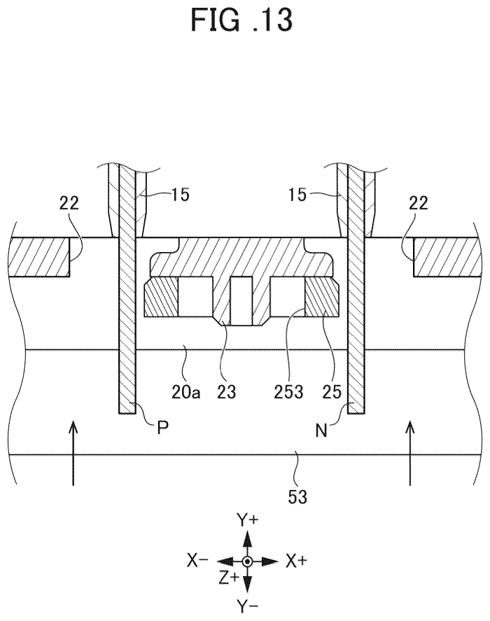

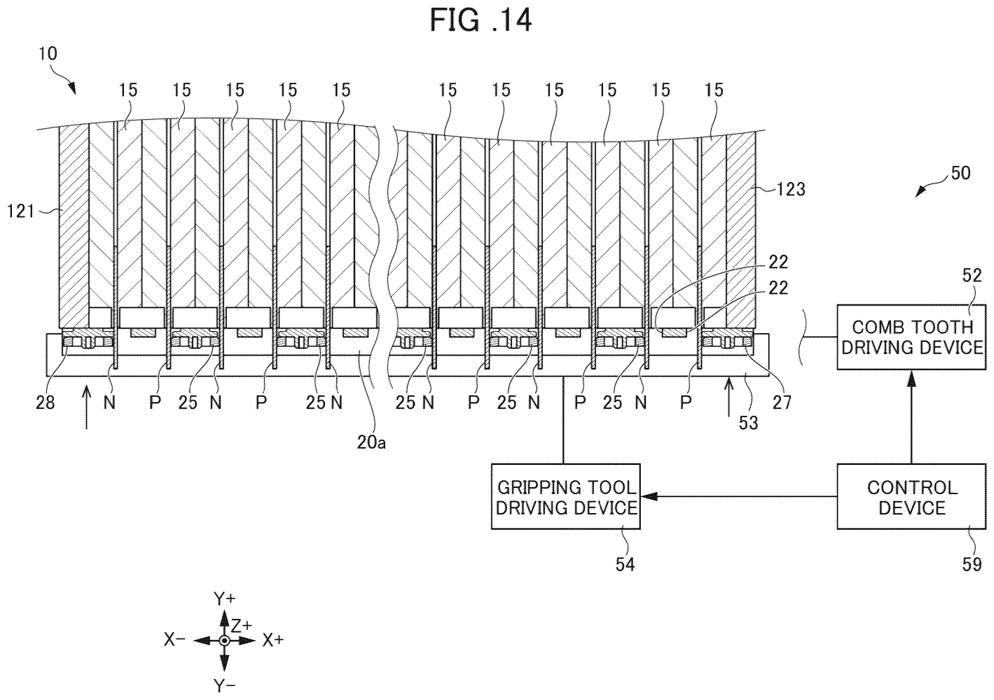

Subsequently, as illustrated in FIG. 13, the holder gripping tool 53 and the first busbar holder 20a are further moved toward the Y+ side. As a result, as illustrated in FIG. 14, the first busbar holder 20a is mounted to the plurality of Y− side tab leads N and P of the cell stack 10.

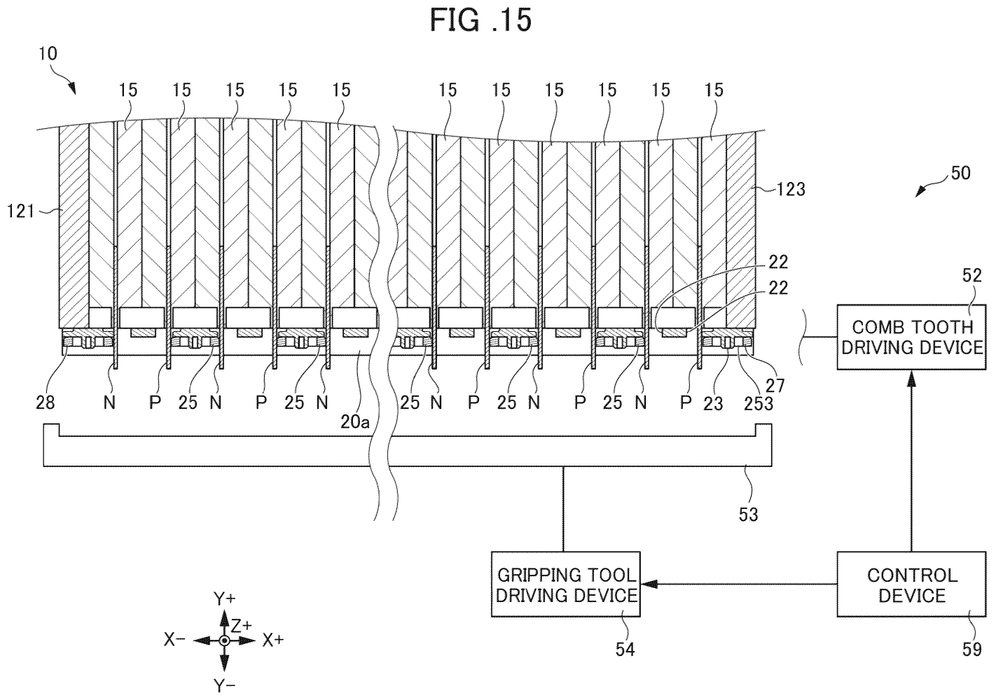

In the releasing control following the mounting control, the grip on the first busbar holder 20a by the holder gripping tool 53 is released, as illustrated in FIG. 15, and the positioning of the busbars 25 to 28 by the positioning recesses 535 illustrated in FIG. 4 is also released. Consequently, as illustrated in FIG. 15, the busbar 25 is arranged between the tab leads P and N, which should be electrically connected, so as to be movable in the X direction within the range of the elongated hole 253 and pivotable around the holding pin 23 as an axis.

The following describes the procedure for mounting the second busbar holder 20b, as illustrated in FIG. 16, to the cell stack 10, to which the first busbar holder 20a has already been mounted.

The operator removes the cell stack 10 illustrated in FIG. 15, to which the first busbar holder 20a has been mounted, from the holder mounting apparatus 50, and rotates the cell stack 10 by 180 degrees around the Z axis. Subsequently, the Y+ side end of the cell stack 10 and the second busbar holder 20b are set in the holder mounting apparatus 50. Then, the holder mounting apparatus 50 is activated.

As a result, the positioning control, the opening control, the mounting control, and the releasing control are each executed again in the substantially same manner as previously described. Through each control, the second busbar holder 20b is mounted to the Y+ side surface of the cell stack 10, as illustrated in FIG. 16.

Hereinafter, the cell stack 10, to which the first busbar holder 20a and the second busbar holder 20b have been mounted, is referred to as the “holder-mounted cell stack 10”.

The following describes the clamping apparatus 70, as illustrated in FIG. 17. The clamping apparatus 70 is configured to be capable of clamping the busbars 25 to 28 of the first busbar holder 20a of the holder-mounted cell stack 10. The clamping apparatus 70 is also configured to be capable of clamping the busbars 25 of the second busbar holder 20b of the holder-mounted cell stack 10.

Hereinafter, the state in which the busbars 25 to 28 of the first busbar holder 20a is clamped by the clamping apparatus 70 is referred to as the “first clamping state”. The state in which the busbars 25 of the second busbar holder 20b is clamped by the clamping apparatus 70 is referred to as the “second clamping state”.

The clamping apparatus 70 illustrated in FIG. 17 is configured as follows, as viewed in the first clamping state.

As illustrated in FIG. 17, the clamping apparatus 70 includes a base member 71, a moving device 72, a plurality of actuation pairs 73, a plurality of drive devices 74, and a control device 79.

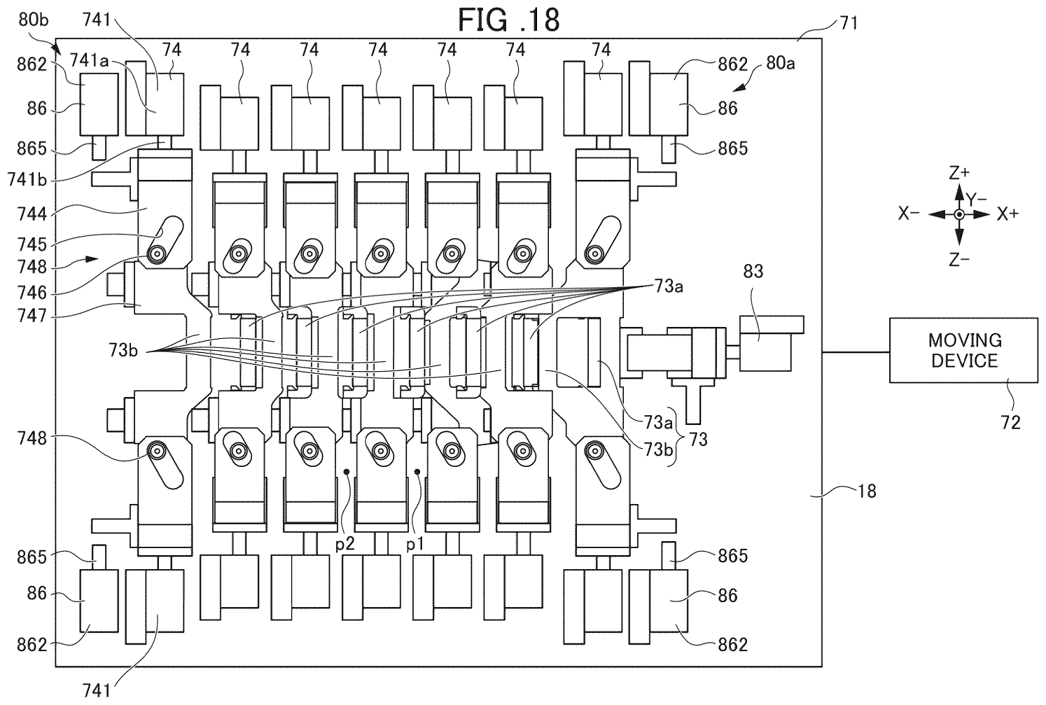

As illustrated in FIG. 18, the base member 71 extends in the X and Z directions. The moving device 72 illustrated in FIG. 17 is configured to be capable of moving the base member 71 in the X and Y directions.

As illustrated in FIG. 17, the actuation pairs 73 are provided for every other busbar among the busbars 25 to 28 arranged side by side in the X direction. Each actuation pair 73 includes a first actuation part 73a and a second actuation part 73b. The first actuation part 73a is mounted to the base member 71 and is arranged closer to the X+ side than the busbar 25 that should be clamped. The second actuation part 73b is mounted to the base member 71 so as to be movable in the X direction and is arranged closer to the X− side than the busbar 25 that should be clamped.

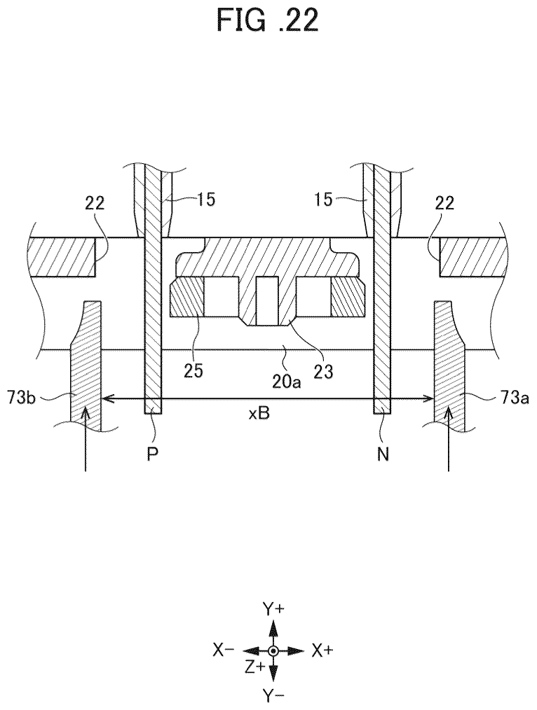

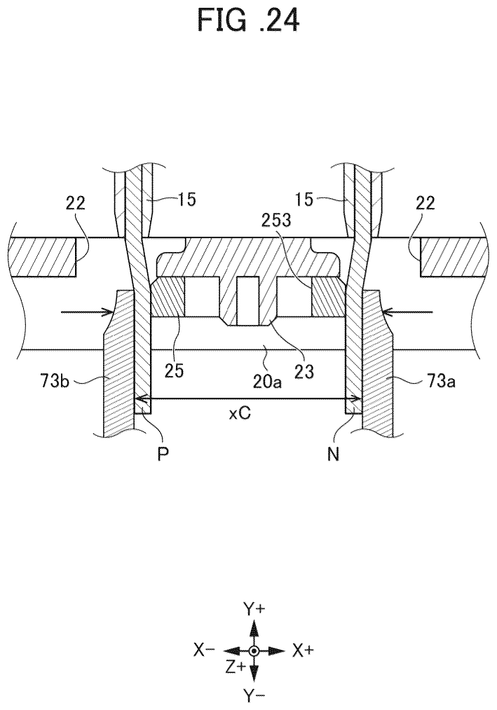

The pitch between the first actuation part 73a and the second actuation part 73b in the X direction changes from the predetermined pre-clamping pitch xB, as illustrated in FIG. 22, to the smaller clamping pitch xC, as illustrated in FIG. 24. This change allows the actuation pairs 73 to clamp the busbar 25 together with the adjacent tab leads P and N in the X direction.

As illustrated in FIG. 18, the drive device 74 is provided for each second actuation part 73b. These drive devices 74 are arranged side by side in the X direction in the base member 71. Each drive device 74 moves the second actuation part 73b in the X direction relative to the base member 71.

Specifically, each drive device 74 includes a pair of air cylinders 741, one on each side of the corresponding second actuation part 73b in the Z direction, and a power conversion mechanism 748 provided for each air cylinder 741. Each air cylinder 741 includes a cylinder body 741a and a rod 741b that protrudes inward from the cylinder body 741a in the Z direction. Each power conversion mechanism 748 converts the force from the rod 741b in the Z direction into a force in the X direction, and transmits the converted force to the second actuation part 73b.

More specifically, the power conversion device 748 includes, for example, a rod-side member 744 that moves along with the rod 741b in the Z direction, and an actuation part-side member 747 that moves along with the second actuation part 73b in the X direction. The rod-side member 744 includes an elongated hole 745 that inclines toward the X+ side as extending outward in the Z direction. On the other hand, the actuation part-side member 747 includes an engagement pin 746 that engages with the elongated hole 745. Thus, the power conversion mechanism 748 converts the force from the pair of rods 741b inward in the Z direction into a force toward the X+ side, and transmits the converted force to the second actuation part 73b. The power conversion mechanism 748 also converts the force from the pair of rods 741b outward in the Z direction into a force toward the X− side, and transmits the converted force to the second actuation part 73b.

Thus, when the air pressure from the pair of air cylinders 741 is OFF, the second actuation part 73b is arranged on the X− side, and the pitch between the second actuation part 73b and the first actuation part 73a in the X direction becomes the pre-clamping pitch xB, as illustrated in FIG. 22. On the other hand, when the air pressure from the pair of air cylinders 741 is ON, the second actuation part 73b is arranged on the X+ side, and the pitch between the second actuation part 73b and the first actuation part 73a in the X direction becomes the clamping pitch xC, as illustrated in FIG. 24.

As illustrated in FIG. 18, the center of gravity of each drive device 74 located closer to the X+ side than the predetermined first position p1 is positioned closer to the X+ side than the center of gravity of the corresponding second actuation part 73b driven by the respective drive device 74. The drive device 74 located closer to the X+ side has a larger displacement of the center of gravity toward the X+ side with respect to the center of gravity of the corresponding second action portion 73b. On the other hand, the center of gravity of each drive device 74, which is located closer to the X− side than the second position p2 that is located further closer to the X− side than the first position p1, is positioned closer to the X− side than the center of gravity of the corresponding second actuation part 73b driven by the respective drive device 74. The drive device 74 located closer to the X− side has a larger displacement of the center of gravity toward the X− side with respect to the center of gravity of the corresponding second action portion 73b.

As illustrated in FIG. 18, the clamping apparatus 70 further includes an X+ side pitch modification device 80a and an X− side pitch modification device 80b. The X+ side pitch modification device 80a is configured to be capable of modifying the pre-clamping pitch xB of the X+ side end actuation pair 73. On the other hand, the X− side pitch modification device 80b is configured to be capable of modifying the pre-clamping pitch xB of the X− side end actuation pair 73. The X+ side pitch modification device 80a includes a first modification device 83 and two second modification devices 86. On the other hand, the X− side pitch modification device 80b includes two second modification devices 86.

The first modification device 83 of the X+ side pitch modification device 80a is configured to be capable of moving the X+ side end first actuation part 73a in the X direction relative to the base member 71. This configuration allows the pre-clamping pitch xB of the X+ side end actuation pair 73 to expand toward the X+ side and contract toward the X− side.

The two second modification devices 86 of the X+ side pitch modification device 80a are configured to be capable of modifying the movable range toward the X− side of the X+ side end second actuation part 73b. This allows the pre-clamping pitch xB of the X+ side end actuation pair 73 to expand toward the X− side and contract toward the X+ side. The X+ side pitch modification device 80a is configured to be capable of freely modifying the positions of the first actuation part 73aand the second actuation part 73b in the X direction, thus configured to be capable of freely modifying the clamping position in the X direction.

The two second modification devices 86 of the X− side pitch modification device 80b are configured to be capable of modifying the movable range toward the X− side of the X− side end second actuation part 73b. This allows the pre-clamping pitch xB of the X− side end actuation pair 73 to expand toward the X− side and contract toward the X+ side.

Specifically, each second modification device 86 modifies the movable range toward outward in the Z direction of the rod 741b of the air cylinder 741, i.e., the movable range when the air pressure is OFF, thereby modifying the movable range toward the X− side of the second actuation part 73b. More specifically, each second modification device 86 includes a stopper 865, on which the rod-side member 744 abuts outward in the Z direction, and a stopper moving device 862 that moves the stopper 865 in the Z direction.

The control device 79 of the clamping apparatus 70 illustrated in FIG. 17 controls the moving device 72, the plurality of drive devices 74, and the two pitch modification devices 80a and 80b, thereby clamping the busbars 25 to 28 of the first busbar holder 20a together with the adjacent tab leads P and N. In other words, the control device 79 automatically executes a predetermined busbar clamping method. Furthermore, the clamping apparatus 70 welds the Y− side end tab leads P and N of the cell stack 10 to the adjacent busbars 25 to 28.

The above has described the clamping apparatus 70 as viewed in the first clamping state, as mentioned earlier.

The following describes the procedure for actually clamping the busbars 25 to 28 and welding the tab leads N and P of the cell stack 10 to the adjacent busbars 25 using the clamping apparatus 70 described above.

First, the operator sets the X+ side part at the Y− side end of the holder-mounted cell stack 10, as illustrated in FIG. 16, into the clamping apparatus 70. The clamping apparatus 70 is then activated.

The control device 79 first causes the two pitch modification devices 80a and 80b illustrated in FIG. 18 to modify the pre-clamping pitch xB of the actuation pairs 73 at both ends in the X direction to a desired pitch. Specifically, the pre-clamping pitch xB of the X+ side end actuation pair 73 is modified to a pitch that is a predetermined amount larger than the width of the positive-side end busbar 27 in the X direction. On the other hand, the pre-clamping pitch xB of the X− side end actuation pair 73 is modified to a pitch that is a predetermined amount larger than the width of the central busbar 26 in the X direction.

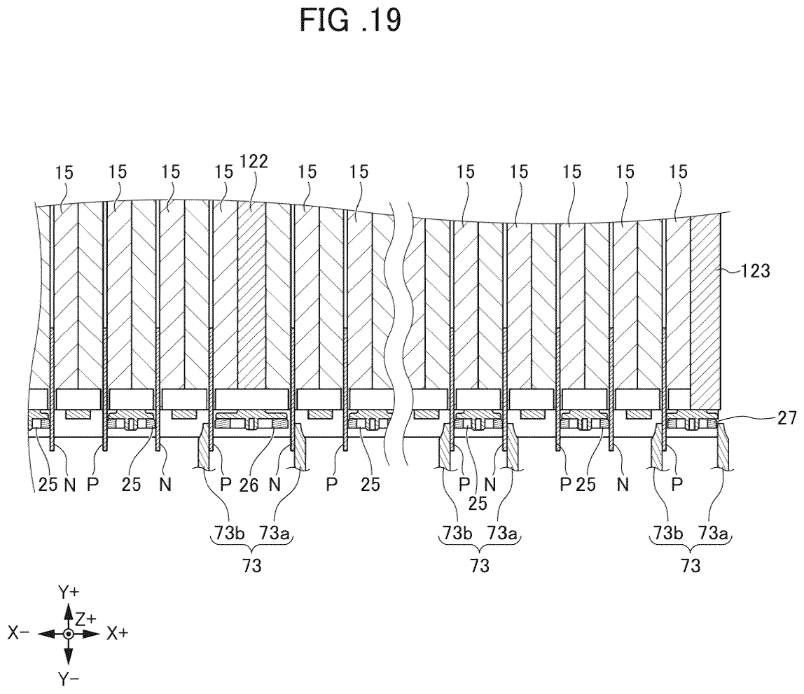

Next, as illustrated in FIG. 19, each of the odd-numbered busbars 26, 25, and 27 is clamped together with the adjacent tab leads P and N by the corresponding actuation pairs 73. The details of this operation will be described later. In this clamped state, the tab leads P and N are welded to the adjacent busbars 26, 25, and 27. Afterward, the control device 79 releases the clamping of the odd-numbered busbars 26, 25, and 27 clamped by the actuation pairs 73.

Next, the control device 79 causes the X+ side pitch modification device 80a illustrated in FIG. 18 to modify the pre-clamping pitch xB of the X+ side end actuation pair 73 to a pitch that is a predetermined amount larger than the width of the normal-width busbar 25 in the X direction. The X− side end actuation pair 73 is not used here; therefore, the pre-clamping pitch xB thereof does not need to be modified in particular.

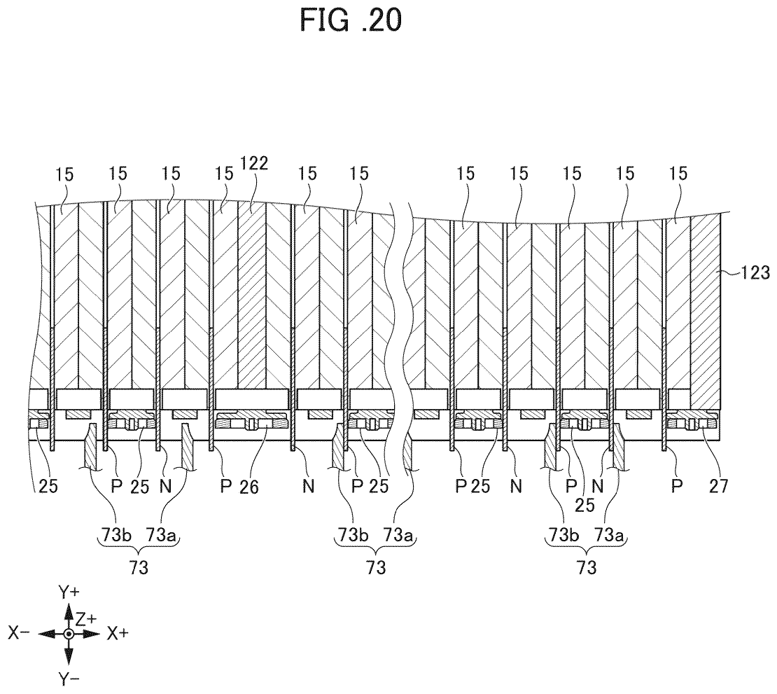

Next, as illustrated in FIG. 20, each of the even-numbered busbars 25 is clamped together with the adjacent tab leads P and N by the corresponding actuation pairs 73, excluding the X− side end actuation pair 73. In this clamped state, the tab leads P and N are welded to the adjacent busbars 25. Afterward, the control device 79 releases the clamping of the even-numbered busbars 25 clamped by the actuation pairs 73.

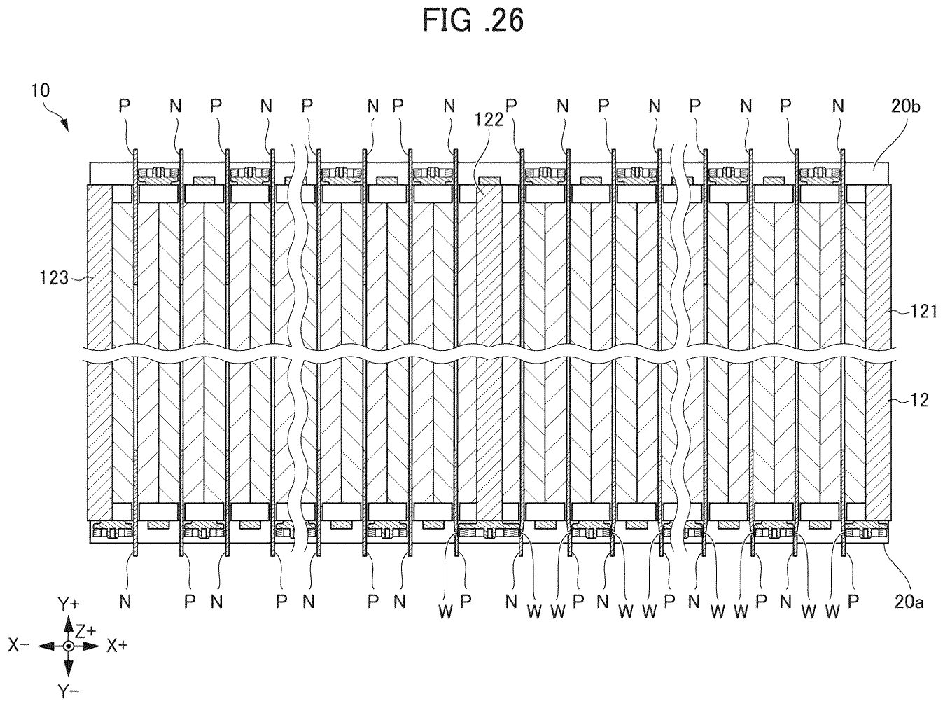

As a result, as illustrated in FIG. 26, the welding W of the tab leads P and N to the adjacent busbars 25 at the X+ side part at the Y− side end of the holder-mounted cell stack 10 is completed.

Next, the operator sets the X− side part at the Y− side end of the holder-mounted cell stack 10 into the clamping apparatus 70. The clamping apparatus 70 is then activated. As a result, similarly to the previous case, the tab leads P and N are welded to the adjacent busbars 25, at the X− side part at the Y− side end.

Next, the operator sets the X− side part at the Y+ side end of the holder-mounted cell stack 10 into the clamping apparatus 70. The clamping apparatus 70 is then activated. As a result, similarly to the previous case, the tab leads P and N are welded to the adjacent busbars 25, at the X− side part at the Y+ side end.

Next, the operator sets the X+ side part at the Y+ side end of the holder-mounted cell stack 10 into the clamping apparatus 70. The clamping apparatus 70 is then activated. As a result, similarly to the previous case, the tab leads P and N are welded to the adjacent busbars 25, at the X+ side part at the Y+ side end.

As a result, as illustrated in FIG. 27, the welding W of the tab leads P and N to the adjacent busbars 25 to 28 throughout the entire cell stack 10 is completed.

The following describes the detailed operation of each actuation pair 73 during the batch clamping and welding described above.

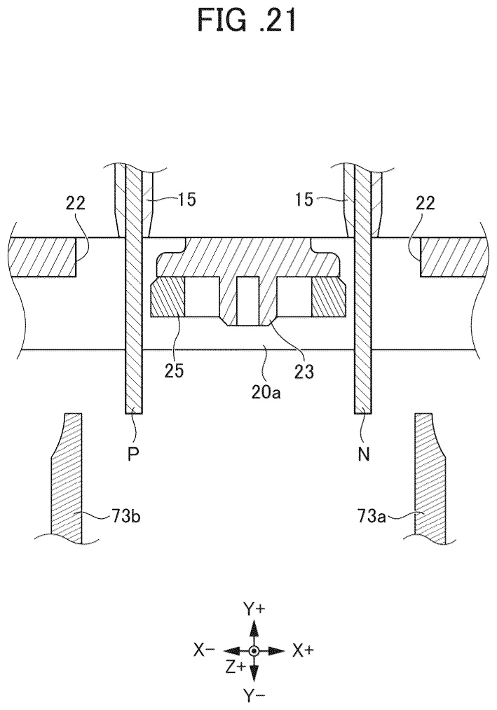

First, from the state where the actuation pairs 73 are arranged closer to the Y− side than the busbar 25 that should be clamped as illustrated in FIG. 21, the control device 59 moves the base member 71 toward the Y+ side as illustrated in FIG. 22. As a result, the actuation pairs 73 is arranged to a position overlapping the busbar 25 that should be clamped, as viewed in the X direction. In other words, the second actuation part 73b is arranged closer to the X− side than the busbar 25 that should be clamped, and the first actuation part 73a is arranged closer to the X+ side than the busbar 25 that should be clamped. At this time, the pitch between the second actuation part 73b and the first actuation part 73a in the X direction is the pre-clamping pitch xB described earlier.

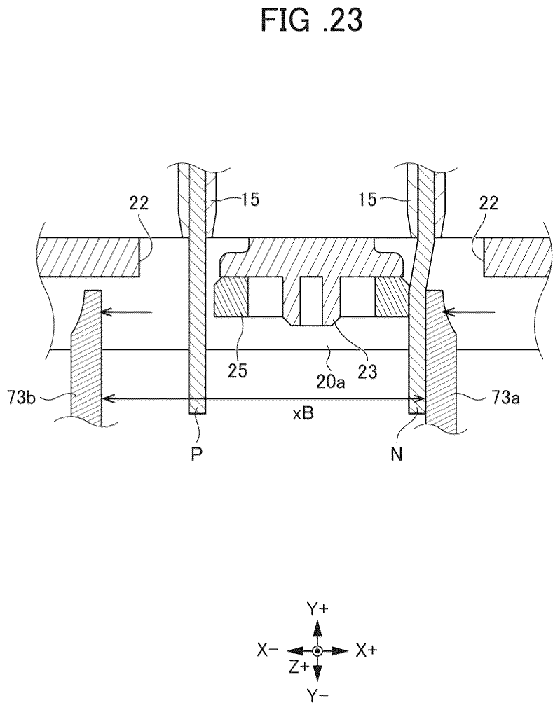

From this state, as illustrated in FIG. 23, the moving device 72 moves the base member 71 toward the X− side. As a result, the second actuation part 73b and the first actuation part 73a move toward the X− side while maintaining the pre-clamping pitch xB. As a result, the second actuation part 73b moves away from the busbar 25 that should be clamped, while the first actuation part 73a moves closer to the busbar 25 that should be clamped. At this time, the first actuation part 73a may or may not abut the busbar 25 that should be clamped.

From this state, as illustrated in FIG. 24, the drive device 74 moves the second actuation part 73b toward the X+ side relative to the base member 71. This causes the actuation pairs 73 to clamp the busbar 25 together with the adjacent tab leads P and N. At this time, the pitch between the second actuation part 73b and the first actuation part 73a in the X direction is the clamping pitch xC described earlier.

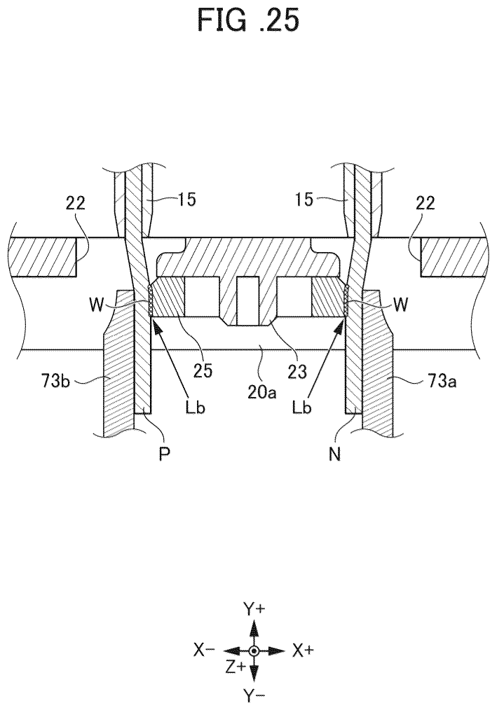

From this state, as illustrated in FIG. 25, a laser Lb is applied between the busbar 25 and the tab leads P and N to execute welding W. As a result, the tab leads P and N on both sides of the busbar 25 are joined to the busbar 25.

The above operations, or similar operations, are executed simultaneously at all the actuation pairs 73, thereby carrying out the batch clamping and welding described earlier.

The following summarizes the configuration and effects of the busbar holders 20a and 20b illustrated in FIG. 16.

As illustrated in FIG. 3, as viewed in the mounting state, the busbars 25 and 26 are held between the insertion holes 22 of the first busbar holder 20a so as to be movable in the X direction relative to the first busbar holder 20a. Therefore, as illustrated in FIG. 14, by inserting the tab leads P and N into the insertion holes 22 and mounting the busbar holder 20a to the end of the cell stack 10 in the Y direction, the busbars 25 and 26 are arranged between the tab leads P and N so as to be movable in the X direction, as illustrated in FIG. 15.

From this state, as illustrated in FIG. 24, by clamping the busbars 25 and 26 together with the tab leads P and N on both sides by the actuation pairs 73, the busbars 25 move to an appropriate position between the tab leads P and N in the X direction within the range of the elongated hole 253. In other words, even if the position of the battery cells 15 in the X direction relative to the busbar holder 20a deviates from the desired position due to expansion of the battery cells 15 or other reasons, the busbar 25 can be moved to an appropriate position in the X direction within the range of the elongated hole 253. This appropriate position is, for example, a position where the clamping forces from both sides in the X direction are balanced. Furthermore, the tab leads P and N on both sides adjacent to the busbar 25 bend following the movement of the busbar 25. Therefore, according to the present embodiment, the busbars 25 can be easily clamped without undue difficulty.

As illustrated in FIG. 3, as viewed in the mounting state, the busbars 25 include the elongated holes 253 formed extending in the X direction. By inserting the holding pins 23 into the corresponding elongated holes 253 in the Y direction, the busbars 25 are held so as to be movable in the X direction relative to the busbar holder 20a. Therefore, the simple configuration including the holding pins 23 and the elongated holes 253 allows for holding the busbars 25 so as to be movable in the X direction relative to the busbar holder 20a.

As illustrated in FIG. 3, as viewed in the mounting state, the elongated hole 253 is provided at the middle portion of the busbar 25 extending in the Z direction. Therefore, the busbar 25 is held by the busbar holder 20a so as to be pivotable about the holding pin 23 as an axis. Thus, the busbar 25 can accommodate any misalignment in the pivotal direction relative to the tab leads P and N.

As illustrated in FIG. 27, in the state of the battery module 30, the busbars 25 to 28 preferably remain stationary relative to the cell stack 10 and the busbar holders 20a and 20b. In this respect, according to the present embodiment, simply by mounting the busbar holders 20a and 20b to the cell stack 10 and welding the tab leads P and N to the adjacent busbars 25 to 28, the busbars 25 to 28 can be positioned in the X direction relative to the cell stack 10 and the busbar holders 20a and 20b.

The following summarizes the configuration and effects of the holder mounting apparatus 50, as illustrated in FIG. 1.

As illustrated in FIG. 4, in the positioning control, the plurality of busbars 25 to 28 are positioned in the X direction relative to the holder gripping tool 53 and the busbar holder 20a. As illustrated in FIG. 10, in the opening control, the comb tooth jigs 51a and 51b are inserted between the tab leads P and N that should be electrically connected, thereby opening the tip ends of the tab leads P and N in the X direction. Therefore, during the subsequent mounting control illustrated in FIG. 11, when the holder gripping tool 53 and the busbar holder 20a are moved toward the cell stack 10 to arrange the busbars 25 between the tab leads P and N, the interference between the busbars 25 and the tab leads P and N can be suppressed. As a result, the operational efficiency during the mounting of the busbar holders 20a and 20b to the cell stack 10 can be ensured.

Furthermore, in the releasing control after the mounting control, the positioning of the busbars 25 in the X direction by the holder gripping tool 53 illustrated in FIG. 4 is released. Therefore, subsequently, as illustrated in FIG. 24, by clamping the busbars 25 together with the adjacent tab leads P and N, the busbars 25 move to an appropriate position in the X direction within the range of the elongated hole 253, as described earlier. Therefore, the busbars 25 to 28 can be easily clamped without undue difficulty.

Thus, according to the present embodiment, the busbars 25 to 28 can be easily clamped without undue difficulty while ensuring the operational efficiency of mounting the busbar holders 20a and 20b to the cell stack 10.

In the mounting control illustrated in FIG. 11, the holder gripping tool 53 and the busbar holder 20a are moved, thereby causing the busbars 25 to overlap the tip ends of the tab leads P and N, as viewed in the X direction. Subsequently, as illustrated in FIG. 12, the comb tooth jigs 51a and 51b are removed from between the tab leads P and N. Thereafter, as illustrated in FIG. 13, the holder gripping tool 53 and the busbar holder 20a are further moved toward the cell stack 10. Therefore, the comb tooth jigs 51a and 51b can be removed at an appropriate timing. As a result, the operational efficiency of mounting the busbar holders 20a and 20b to the cell stack 10 can be further enhanced.

As illustrated in FIG. 5, the busbars 25 to 28 include the pair of protrusions 255 protruding in the Y direction. The holder gripping tool 53 includes the positioning recesses 535 that engage with the pair of protrusions 255. Therefore, the simple configuration including the pair of protrusions 255 and the positioning recesses 535 allows the busbars 25 to be positioned in the X direction relative to the holder gripping tool 53.

According to the first embodiment of the positioning recess 535 as illustrated in FIG. 5, the side surfaces of the pair of protrusions 255 abut the inner surfaces of the positioning recess 535, thereby positioning the busbars 25 in the X direction relative to the holder gripping tool 53. Furthermore, the tips of the pair of protrusions 255 abut the bottom surface of the positioning recess 535, thereby positioning the busbars 25 in the Y direction relative to the holder gripping tool 53. Therefore, the busbars 25 can be positioned in both the X and Y directions relative to the holder gripping tool 53.

According to the second aspect of the positioning recess 535 illustrated in FIG. 6, the width of the positioning recess 535 in the X direction narrows toward the Y− side. The side surfaces of the protrusions 255 abut the inner surfaces of the positioning recess 535, thereby positioning the busbars 25 in the X and Y directions relative to the holder gripping tool 53. Thus, with the second aspect as well, the busbars 25 can be positioned in both the X and Y directions relative to the holder gripping tool 53.

The following summarizes the configuration and effects of the clamping apparatus 70 illustrated in FIG. 17. As illustrated in FIG. 24, the control device 79 causes the drive device 74 to move the second actuation part 73b to the X+ side. The busbars 25 are clamped in the X direction by the second actuation part 73b and the first actuation part 73a. Therefore, as illustrated in FIG. 17, among the second actuation part 73b and the first actuation part 73a, only the second actuation part 73b requires the drive device 74. This simplifies the driving system of the actuation pair 73 compared to a system that requires the drive devices 74 for both the second actuation part 73b and the first actuation part 73a.

Moreover, as illustrated in FIG. 23, the control device 79 moves the base member 71 to the X− side, moves the first actuation part 73a to the X− side, and then moves the second actuation part 73b to the X+ side, as illustrated in FIG. 24. As a result, the busbars 25 are clamped in the X direction by the second actuation part 73b and the first actuation part 73a. Thus, by moving the first actuation part 73a in the X direction by the movement of the base member 71, the functionality of the clamping operation of the busbar 25 can be ensured.

Thus, according to the present embodiment, the driving system of the actuation pairs 73 can be simplified while ensuring the functionality of the clamping operation of the busbars 25 to 28.

The control device 79 illustrated in FIG. 17 executes batch clamping to clamp the plurality of busbars 25 all together by using the plurality of actuation pairs 73, as illustrated in FIG. 19. This batch clamping allows for efficient clamping of the plurality of busbars 25.

The control device 79 first executes batch clamping on the odd-numbered busbars 25 as illustrated in FIG. 19, and then executes batch clamping on the even-numbered busbars 25 as illustrated in FIG. 20. Therefore, as illustrated in FIG. 17, the actuation pairs 73 only need to be provided for every other busbar among the plurality of busbars 25 to 28 arranged side by side in the X direction. As a result, the installation space for the actuation pairs 73 and the corresponding drive devices 74 can be easily secured.

As illustrated in FIG. 18, the drive devices 74 are arranged side by side in the X direction. Each drive device 74 includes the air cylinder 741 that applies a force in the Z direction, and the power conversion mechanism 748 that converts the force from the air cylinder 741 in the Z direction into a force in the X direction and transmits the converted force to the second actuation part 73b. As such, each drive device 74 includes the air cylinder 741 that applies a force in the Z direction, thus tends to be longer in the Z direction but more compact in the X direction. Therefore, in this regard as well, the installation space for the drive devices 74 arranged side by side in the X direction can be easily secured in the X direction.

As illustrated in FIG. 18, the center of gravity of each drive device 74 located closer to the X+ side than the predetermined first position p1 is displaced more toward the X+ side than the center of gravity of the corresponding second actuation part 73b driven by the drive device 74. On the other hand, the center of gravity of each drive device 74 located closer to the X− side than the second position p2 is displaced more toward the X− side than the center of gravity of the corresponding second actuation part 73b driven by the drive device 74. Therefore, even in a case where the actuation pairs 73 are densely arranged side by side in the X direction, the drive devices 74 can be easily arranged as spread out in the X direction. As a result, in this regard as well, the installation space for the drive devices 74 arranged side by side in the X direction can be easily secured in the X direction.

The following summarizes the configuration and effects of the pitch modification devices 80a and 80b, as illustrated in FIG. 18.

The pitch modification devices 80a and 80b illustrated in FIG. 18 modify the pre-clamping pitch xB of the actuation pair 73 at the ends in the X direction. Therefore, in a case where the busbars clamped by the actuation pair 73 at the ends in the X-direction are the special-width busbars 26 to 28, the pitch modification devices 80a and 80b can modify the pre-clamping pitch xB of the actuation pair 73 to match the special-width busbars 26 to 28. In a case where the busbars clamped by the actuation pair 73 at the ends of the X-direction are the normal-width busbars 25, the pitch modification devices 80a and 80b can modify the pre-clamping pitch xB of the actuation pair 73 to match the normal-width busbars 25. Therefore, this configuration can accommodate both the special-width busbars 26 to 28 and the normal-width busbars 25.

The control device 79 illustrated in FIG. 17 clamps the odd-numbered busbars 25 using the plurality of actuation pairs 73, as illustrated in FIG. 19. Thereafter, the pitch modification devices 80a and 80b illustrated in FIG. 18 modify the pre-clamping pitch xB of the actuation pair 73 at the ends in the X-direction. Subsequently, as illustrated in FIG. 20, the even-numbered busbars 25 are clamped using the actuation pairs 73. Therefore, this configuration can accommodate the case where, as in the present embodiment, the odd-numbered busbars at the ends in the X-direction are the special-width busbars 26 and 28, and the even-numbered busbars at the ends in the X-direction are the normal-width busbars 25.

Specifically, in the present embodiment, as illustrated in FIG. 16, the plurality of battery cells 15 are housed between the end plates 121 and 123 and the center plate 122. The busbars 27 and 28 adjacent to the end plates 121 and 123, and the busbar 26 adjacent to the center plate 122, are the special-width busbars 26 to 28. Therefore, this configuration can accommodate the special-width busbars 26 to 28.

The first modification device 83 illustrated in FIG. 18 modifies the arrangement of the first actuation part 73arelative to the base member 71 in the X direction, thereby allowing the pre-clamping pitch xB to be expanded toward the X+ side or contracted toward the X− side. Therefore, this simple configuration allows the pre-clamping pitch xB to be expanded toward the X+ side or contracted toward the X− side.

The second modification device 86 illustrated in FIG. 18 modifies the movable range of the second actuation part 73b in the X-direction relative to the base member 71, thereby allowing the pre-clamping pitch xB to be expanded toward the X− side or contracted toward the X+ side. Therefore, this simple configuration allows the pre-clamping pitch xB to be expanded toward the X− side or contracted toward the X+ side.

More specifically, the second modification device 86 modifies the movable range outward in the Z-direction of the rod 741b of the air cylinder 741. As a result, the movable range of the second actuation part 73b in the X− side relative to the base member 71 can be modified. Consequently, the pre-clamping pitch xB can be expanded toward the X− side or contracted toward the X+ side. Thus, this simple configuration allows the pre-clamping pitch xB to be expanded toward the X− side or contracted toward the X+ side.

### Other Embodiments

The embodiment described above can be modified, for example, in the following manners. The holder mounting apparatus 50 illustrated in FIG. 1, may not necessarily need to include the control device 59. The various controls executed by the control device 59 may be manually executed by the operator as individual steps. The clamping apparatus 70 illustrated in FIG. 17 may not necessarily need to include the control device 79. The various controls executed by the control device 79 may be manually executed by the operator as individual steps.

The pitch modification devices 80a and 80b may be provided for other actuation pairs 73, instead of or in addition to the actuation pairs 73 at the ends in the X-direction. This modification may allow the pitch of any actuation pair 73 to be modified.

### EXPLANATION OF REFERENCE NUMERALS

10: cell stack
15: battery cell
25: normal-width busbar
26: central busbar
27: positive-side end busbar
28: negative-side end busbar
70: clamping apparatus (busbar clamping apparatus)
71: base member
72: moving device (mover)
73: actuation pair
73a: first actuation part
73b: second actuation part
74: drive device (driver)
741: air cylinder
748: power conversion device (power converter)
79: control device (controller)
N: negative electrode-side tab lead
P: positive electrode-side tab lead
p1: first position
p2: second position

What is claimed is:

1. A busbar clamping apparatus that clamps busbars together with adjacent tab leads in a cell stack that includes a plurality of battery cells arranged side by side in a predetermined X direction, each of the plurality of battery cells including a corresponding one of the tab leads protruding in a Y direction orthogonal to the X direction, the busbar clamping apparatus comprising:
a base member;
a mover that moves the base member;
a first actuation part mounted to the base member and arranged closer to an X+ side, which is one side in the X direction, than the busbars that should be clamped;
a second actuation part mounted so as to be movable in the X direction relative to the base member and arranged closer to an X− side, which is a side opposite to the X+ side, than the busbars that should be clamped;
a driver that moves the second actuation part in the X direction relative to the base member; and
a controller that controls the mover and the driver, wherein
the controller causes the mover to move the base member toward the X− side to move the first actuation part toward the X− side, and then causes the driver to move the second actuation part toward the X+ side, thereby causing the first actuation part and the second actuation part to clamp the busbars in the X direction.

2. The busbar clamping apparatus according to claim 1, wherein the busbars are held so as to be movable in the X direction.

3. The busbar clamping apparatus according to claim 1, further comprising a plurality of actuation pairs, each including the first actuation part and the second actuation part, wherein
the controller executes batch clamping to clamp the plurality of busbars all together by using the plurality of actuation pairs.

4. The busbar clamping apparatus according to claim 3, wherein the controller executes the batch clamping for either, from the X+ side toward the X− side, odd-numbered or even-numbered busbars and then executes the batch clamping for the other of the odd-numbered or even-numbered busbars.

5. The busbar clamping apparatus according to claim 1, wherein
a plurality of the drivers are arranged side by side in the X direction, and
each of the drivers includes: an air cylinder that applies a force in a Z direction orthogonal to the X and Y directions; and a power converter that converts the force in the Z direction from the air cylinder into a force in the X direction and transmits the converted force to the second actuation part.

6. The busbar clamping apparatus according to claim 1, wherein,
within a range located on the X+ side beyond a predetermined first position, the center of gravity of each driver closer to the X+ side is displaced more toward the X+ side than the center of gravity of the corresponding second actuation part driven by that driver, and
within a range located on the X− side beyond a predetermined second position, which is located on the X− side further beyond the first position, the center of gravity of each driver closer to the X− side is displaced more toward the X− side than the center of gravity of the corresponding second actuation part driven by that driver.
